(19) United States
(12) Patent Application Publication
(10) Pub. No.: US 2016/0210038 A1
(43) Pub. Date: Jul. 21, 2016

(54) ELECTRONIC INKING

(71) Applicant: Microsoft Technology Licensing, LLC, Redmond, WA (US)

(72) Inventors: Krishnan Menon, Redmond, WA (US); Francis Zhou, Redmond, WA (US); Xiao Tu, Medina, WA (US); Aleksandr Klimov, Vancouver BC (CA); Fei Xiong, Redmond, WA (US)

(21) Appl. No.: 14/644,096

(22) Filed: Mar. 10, 2015

Related U.S. Application Data
(60) Provisional application No. 62/106,178, filed on Jan. 21, 2015.

(51) Int. Cl. G06F 3/0488; G06F 3/033

(52) U.S. Cl. CPC G06F 3/04883; G06F 3/033

(57) ABSTRACT

A facility for handling input relating to electronic ink is described. In a first thread, the facility produces ink in response to at least a portion of the input. In a second thread distinct from the first thread, the facility manipulates at least a portion of the ink produced in the first thread.

### CROSS-REFERENCE TO RELATED APPLICATION(S)

This application claims the benefit of U.S. Provisional Application No. 62/106,178, filed on Jan. 21, 2015, which is hereby incorporated by reference in its entirety. In cases in which a document incorporated by reference herein is inconsistent with contents of this application, the contents of this application control.

### TECHNICAL FIELD

The described technology is directed to the field of electronic device input techniques, and, more particularly, to the field of electronic ink.

### BACKGROUND

Electronic ink is content added to an electronic document based upon a user input technique where the user handwrites, draws, or performs other arbitrary spatial movements. As a result of such user input, visual marks are added to the document that correspond to the path of the movement. For example, in the case of handwriting, handwritten words appear in the document in the same handwriting style that they were executed by the user.

In some cases, the user performs this input by moving a stylus or his or her finger across the surface of the display device on which the document is displayed. In such cases, the electronic ink generally appears in the document in the positions where the interactions occurred. In some cases, the user performs the inking input by moving a displayed position pointer on the screen, using an input device such as a mouse or touchpad.

In the case of electronic ink corresponding to handwriting, handwriting recognition techniques can be used to identify text represented by the handwriting, which can be inserted in the document along with or in place of the electronic ink handwriting.

InkPresenter is one interface usable by application programs to collect and manage electronic ink in connection with the application's documents. The InkPresenter interface is described, e.g., by Julia Lerman, Create Web Apps You Can Draw On with Silverlight 2, MSDN Magazine, August, 2008, available at msdn.microsoft.com/en-us/magazine/cc721604.aspx; InkPresenter, Microsoft Developer Network, available at msdn.microsoft.com/en-us/library/bb980020(v=vs.95).aspx; and InkPresenter, Microsoft TechNet, available at technet.microsoft.com/en-us/subscriptions/bb980020(v=vs.95).aspx, each of which is hereby incorporated by reference.

### SUMMARY

A facility for handling input relating to electronic ink is described. In one example facility, in a first thread, the facility produces ink in response to at least a portion of the input. In a second thread distinct from the first thread, the facility manipulates at least a portion of the ink produced in the first thread.

### BRIEF DESCRIPTION OF THE DRAWINGS

FIG. 1 is a block diagram showing some of the components that may be incorporated in at least some of the computer systems and other devices on which the facility operates.

FIG. 2 is a flow diagram showing example acts that may be performed by the facility in some examples.

### DETAILED DESCRIPTION

The inventors have recognized significant potential value in the ability to simultaneously ink on the same display with a large number pointers, such as 5, 10, or more pointers. This is particularly true for devices whose displays have a relatively large area, such as displays having a diagonal dimension of 55 inches, or of 84 inches, but is also true for devices whose displays have a variety of smaller areas.

The inventors have observed that conventional techniques for inking tend to be resource-intensive, such that, on typical processing hardware, simultaneous inking for a large number of pointers is either impossible, or performs poorly. Where conventional techniques prove capable of simultaneous inking for a large number of pointers, such inking is typically attended by performance problems, such as inking that significantly lags pointer movement in time, such that users have trouble noting and correcting deviations from their intended paths, or feel uncertainty and insecurity about whether their pointer movements are even being effectively tracked. To the extent that conventional solutions do not suffer from such lag, it is often because tracking and inking are performed at inadequate levels of resolution, such that the paths of the ink diverges significantly from the paths of the pointers, and/or that the paths of the ink are of a inaccurately jagged shape, or otherwise of low quality.

In response to their recognition of these disadvantages of conventional inking techniques, the inventors have conceived and reduced to practice a software and/or hardware facility that performs an optimized technique for document inking (“the facility”).

In some examples, the facility uses two different threads of execution to perform the inking process: a “create thread” and a “host thread.” (In some examples, the create thread and host thread are each a construct for scheduling the execution of a sequence of instructions by a processor core.) Code running in the create thread handles the generation of ink, while code running in the host thread handles related tasks, such as the erasing, selection, and movement of ink. In general, the facility seeks to have the create thread run at the greatest practicable overall execution rate and level of constancy, and have low-latency access to pointer position input. For example, the facility may cause the create thread to be a background thread owned by the operating system as a way of limiting the ways in which applications can affect its performance. The facility may cause the create thread to be marked as having a high priority for scheduling as a way of causing the create thread to be heavily favored in processor scheduling. The facility may cause the create thread to be registered to receive pointer position input before any other thread, so that the create thread receives such input with as little delay as possible. The facility may cause the create thread to have exclusive access to resources it needs, to prevent the thread from blocking on such resources at times of resource contention. The facility may cause the create thread to use ink primitives that don't require the allocation or use of DirectX resources to perform inking, and/or use an operating system compositor to render ink.

In some examples, the facility provides an API that permits ink-aware applications to run code in the create thread in a limited way. For example, such application code may prevent inking for a pointer that is in a region of the display that the application has reserved for some other purpose. In some examples, the facility coerces such application code to run in a special namespace, and/or throws an exception if the application code runs for more than a maximum amount of time, such as about 20 ms.

In various examples, the facility causes the host thread to handle erasing, selection, and movement of ink and various other activities related to inking. In some examples, the facility causes the host thread to be owned by an application, such as a drawing application, that is consuming the ink. The code executed by the host thread can implement logic specified as part of the application for ink erasing, ink selection, ink movement, and so on.

By performing in some or all of the ways discussed above, the facility makes it significantly more likely that typical processing hardware can produce high-quality, low-lag ink for a large number of simultaneously-moving pointers. This permits such inking to be performed on typical processing hardware, typically without the need for expensive specialized or high-capability processing hardware.

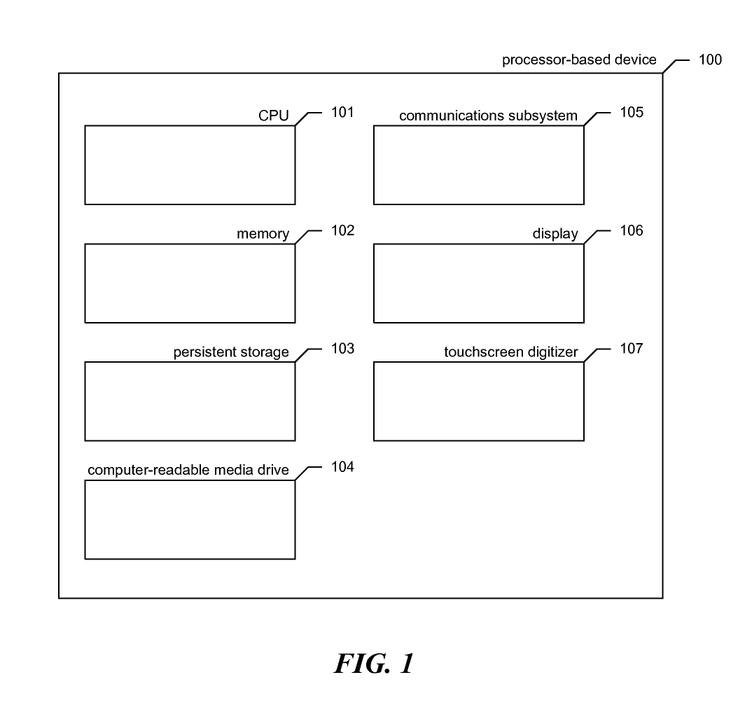

FIG. 1 is a block diagram showing some of the components that may be incorporated in at least some of the computer systems and other devices on which the facility operates. In various examples, these computer systems and other devices 100 can include server computer systems, desktop computer systems, laptop computer systems, tablet computer systems, netbooks, mobile phones, personal digital assistants, televisions, cameras, automobile computers, electronic media players, electronic kiosk devices, electronic table devices, electronic whiteboard devices, etc. In various examples, the computer systems and devices may include any number of the following: a central processing unit (“CPU”) 101 for executing computer programs; a computer memory 102 for storing programs and data while they are being used, including the facility and associated data, an operating system including a kernel and device drivers, and one or more applications; a persistent storage device 103, such as a hard drive or flash drive for persistently storing programs and data; a computer-readable media drive 104, such as a floppy, CD-ROM, or DVD drive, for reading programs and data stored on a computer-readable medium; and/or a communications subsystem 105 for connecting the computer system to other computer systems and/or other devices to send and/or receive data, such as via the Internet or another wired or wireless network and its networking hardware, such as switches, routers, repeaters, electrical cables and optical fibers, light emitters and receivers, radio transmitters and receivers, and the like.

In various examples, these computer systems and other devices 100 may further include any number of the following: a display 106 for presenting visual information, such as text, images, icons, documents, menus, etc.; and a touchscreen digitizer 107 for sensing interactions with the display, such as touching the display with one or more fingers, styluses, or other objects. In various examples, the touchscreen digitizer uses one or more available techniques for sensing interactions with the display, such as resistive sensing, surface acoustic wave sensing, surface capacitance sensing, projected capacitance sensing, infrared grid sensing, infrared acrylic projection sensing, optical imaging sensing, dispersive signal sensing, and acoustic pulse recognition sensing. In various examples, the computer systems and other devices 100 include input devices of various other types, such as keyboards, mice, styluses, etc. (not shown).

While computer systems configured as described above may be used to support the operation of the facility, those skilled in the art will appreciate that the facility may be implemented using devices of various types and configurations, and having various components.

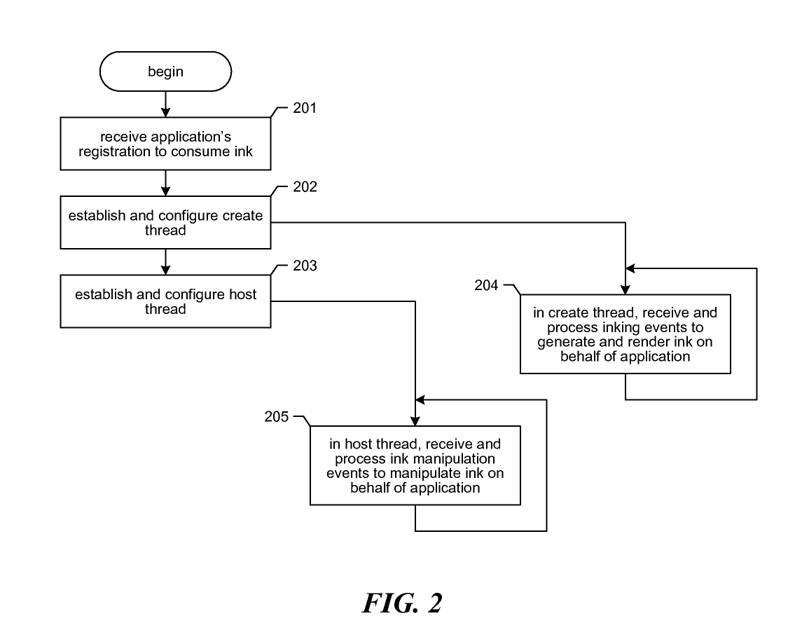

Those skilled in the art will appreciate that the steps shown in FIG. 2 may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

FIG. 2 is a flow diagram showing example acts that may be performed by the facility in some examples. In some examples, the steps of FIG. 2 are performed by one or more components of an operating system executing a computing system. In various other examples, the steps of FIG. 2 are performed by programs of a variety of other types.

At 201, the facility receives from an application a registration to consume ink. After receiving the registration, at 202, the facility establishes and configures the create thread, which proceeds to execute independently to perform the processing of act 204 described below. For example, the facility may cause the create thread to be a background thread owned by the operating system as a way of limiting the ways in which applications can affect its performance. The facility may cause the create thread to be marked as having a high priority for scheduling as a way of causing the create thread to be heavily favored in processor scheduling; for example, the create thread may be marked with a priority higher than that of any thread created by an application, or higher than that of any thread owned by an application. The facility may cause the create thread to be registered to receive pointer position input before any other thread, so that the create thread receives such input with as little delay as possible. In some examples, rather than establishing and configuring a single create thread at 202 to perform the processing of act 204 described below, the facility establishes and configures a pool of two or more create threads to do so.

At 203, the facility establishes and configures the host thread, which proceeds to execute independently to perform the processing of act 205 described below. In some examples, the facility causes the host thread to be owned by the application. In some examples, rather than establishing and configuring a single host thread at 203 to perform the processing of act 205 described below, the facility establishes and configures a pool of two or more host threads to do so.

At 204, in the create thread, the facility receives and processes inking events to generate and render ink on behalf of the application. In some examples, generating the ink constitutes building data structures describing the ink, while rendering ink describes causing a visual representation of the ink to be displayed, such as in the context of the application's document. In some examples, as part of this process, the facility causes the create thread to have exclusive access to resources it needs, thereby preventing the thread from blocking on such resources at times of resource contention. In some examples, the facility causes the create thread to use ink primitives that don't require the allocation or use of DirectX resources to perform inking, and/or use an operating system compositor to render ink.

In some examples, the facility provides an API that permits ink-aware applications to run code in the create thread in a limited way. For example, such application code may prevent inking for a pointer that is in a region of the display that the application has reserved for some other purpose. In some examples, the facility coerces such application code to run in a special namespace, and/or throws an exception if the application code runs for more than a maximum amount of time, such as about 20 ms.

In some examples, the facility continues performing act 204 as long as ink is being consumed by the application.

At 205, in the host thread, the facility receives and processes ink manipulation events to manipulate ink on behalf of the application. In various examples, the host thread handles erasing, selection, and movement of ink and various other activities related to inking. The code executed by the host thread can implement logic specified as part of the application for ink erasing, ink selection, ink movement, and so on. In some examples, the facility continues performing act 205 as long as ink is being consumed by the application.

In some examples (not shown), the facility also establishes and configures one or more rerendering threads to perform such rerendering tasks such as panning and zooming ink.

In some examples, a method in a computing system having one or more processors for handling input relating to electronic ink is performed. The method comprises: receiving input that specifies, over time, for each of two or more pointers, a two-dimensional path through which the pointer moves; with one of the one or more processors, in a first thread, producing ink in response to at least a portion of the received input; and, with one of the one or more processors, in a second thread distinct from the first thread, manipulating at least a portion of the ink produced in the first thread.

In some examples, a computer-readable medium having contents configured to cause a computing system having one or more processors to perform a method for handling input relating to electronic ink is provided. The method comprises: with one of the one or more processors, in a first thread, producing ink in response to at least a portion of the input; and, with one of the one or more processors, in a second thread distinct from the first thread, manipulating at least a portion of the ink produced in the first thread in response to at least a portion of the input.

In some examples, a computing system is provided. The computing system comprises: an interface configured to communicatively connect one or more input devices each providing positional input for one or more pointers; at least one processor core; a memory containing: first code configured for execution on at least one of the processor cores in a first thread, the first code configured to produce ink in response to positional input received for the pointers by the interface, and second code configured for execution on at least one of the processor cores in a second thread distinct from the first thread, the second code configured to manipulate at least a portion of the ink produced in the first thread.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in a computing system having one or more processors configured to handle input associated with electronic ink, the method comprising:
receiving input that specifies, over time, for each of two or more pointers, a two-dimensional path through which the pointer moves;
with one of the one or more processors, in a first thread, producing ink in response to at least a portion of the received input; and
with one of the one or more processors, in a second thread distinct from the first thread, manipulating at least a portion of the ink produced in the first thread.

2. A computer-readable medium having contents configured to cause a computing system having one or more processors to perform a method for handling input associated with electronic ink, the method comprising:
with one of the one or more processors, in a first thread, producing ink in response to a first portion of the input; and
with one of the one or more processors, in a second thread distinct from the first thread, manipulating at least a portion of the ink produced in the first thread in response to a second portion of the input.

3. The computer-readable medium of claim 2 wherein the second portion of the input is distinct from the first portion of the input.

4. The computer-readable medium of claim 2 wherein the second portion of the input comprises input not among the first portion of the input.

5. The computer-readable medium of claim 2, further comprising storing a document containing at least a portion of the ink produced in the first thread.

6. The computer-readable medium of claim 2 wherein the producing ink in response to at least a portion of the input includes, during a period that is less than or equal to one second, producing ink in the first thread corresponding to each of at least five independent pointers.

7. The computer-readable medium of claim 2 wherein the producing ink in response to at least a portion of the input includes, during a period that is less than or equal to one second, producing ink in the first thread corresponding to each of at least ten independent pointers.

8. The computer-readable medium of claim 2 wherein the producing ink in response to at least a portion of the input includes, during a period that is less than or equal to one second, producing ink in the first thread corresponding to each of at least thirty independent pointers.

9. The computer-readable medium of claim 2 wherein the first thread receives input relating to electronic ink before any other thread.

10. The computer-readable medium of claim 2 wherein the first thread is a background thread.

11. The computer-readable medium of claim 2 wherein the first thread is owned by an operating system executing on the computing system.

12. The computer-readable medium of claim 2 wherein the first thread is assigned a scheduling priority higher than any thread created by an application.

13. The computer-readable medium of claim 2 wherein the first thread is assigned a scheduling priority higher than any thread owned by an application.

14. The computer-readable medium of claim 2, the method further comprising, with one of the one or more processors, in the first thread, rendering ink produced in the first thread using an operating system compositor.

15. The computer-readable medium of claim 2, the method further comprising enforcing a maximum execution time against code executed in the first thread that is part of an application that is executing on the computing system and consuming ink produced in the first thread.

16. The computer-readable medium of claim 2 wherein the second thread is owned by an application that is executing on the computing system and consuming ink produced in the first thread.

17. The computer-readable medium of claim 2 wherein the ink manipulation performed in the second thread comprises erasing of ink generated in the first thread.

18. The computer-readable medium of claim 2 wherein the ink manipulation performed in the second thread comprises selection of a proper subset of the ink generated in the first thread.

19. The computer-readable medium of claim 2 wherein the ink manipulation performed in the second thread comprises movement of ink generated in the first thread.

20. The computer-readable medium of claim 2, further comprising, with one or more of the processors, in a third thread distinct from the first and second threads, rerendering at least a portion of the ink produced in the first thread in response to a third portion of the input.

21. The computer-readable medium of claim 2, further comprising, with one or more of the processors, in a third thread distinct from the first and second threads, producing ink in response to a third portion of the input.

22. The computer-readable medium of claim 2, further comprising, with one or more of the processors, in a third thread distinct from the first and second threads, manipulating at least a portion of the ink produced in the first thread in response to a second portion of the input.

23. A computing system, comprising:
an interface configured to communicatively connect one or more input devices each configured to provide positional input for one or more pointers;
at least one processor core; and
a memory containing:
first code configured for execution on at least one of the processor cores in a first thread, the first code configured to produce ink in response to positional input received for the pointers by the interface; and
second code configured for execution on at least one of the processor cores in a second thread distinct from the first thread, the second code configured to manipulate at least a portion of the ink produced by execution of the first code in the first thread.
